(19) United States
(12) Patent Application Publication
(10) Pub. No.: US 2025/0066033 A1
(43) Pub. Date: Feb. 27, 2025

(54) ASSEMBLY FOR A TANK

(71) Applicant: SAFRAN AEROSYSTEMS, PLAISIR (FR)

(72) Inventors: Valerie BRIAND, MOISSY-CRAMAYEL (FR); Jorge Arturo SOTO PUENTE, MOISSY-CRAMAYEL (FR); Aurélien HERICHER, MOISSY-CRAMAYEL (FR)

(73) Assignee: SAFRAN AEROSYSTEMS, PLAISIR (FR)

(21) Appl. No.: 18/723,308

(22) PCT Filed: Dec. 21, 2022
(86) PCT No.: PCT/FR2022/052462

§ 371 Date: Jun. 24, 2024

(30) Foreign Application Priority Data
Dec. 22, 2021 (FR) FR2114276

(51) Int. Cl. B64D 37/06; B64D 37/32

(52) U.S. Cl. CPC B64D 37/06; B64D 37/32

(57) ABSTRACT

An assembly includes an inner wall delimiting a cavity, the inner wall having a first surface facing the cavity, and a second surface opposite the first surface with respect to the cavity, and a sealing device attached to the second surface and including a sealing layer including a material expandable when an opening is formed in the inner wall, and a guide attached to the sealing layer so as to exert a stress on the sealing layer to control a direction of expansion of the material of the sealing layer. The sealing layer has a first face and a second face, and the guide includes a first film attached to the first face and a second film attached to the second face.

### FIELD OF THE INVENTION

This invention relates to the sealing of a wall of a tank which might become punctured, typically for a liquid tank of an aircraft.

### PRIOR ART

An aircraft, such as a helicopter, generally comprises at least one tank suitable for storing a liquid such as fuel. However, a wall of the tank may become punctured during the operation of the aircraft, typically by a projectile. Such a puncture is liable to cause a significant loss of liquid from the tank, and therefore to compromise the safety of the aircraft. To palliate this problem, mechanisms for sealing the puncture have been developed to limit the fluid leak. However, the effectiveness of these mechanisms can be further improved.

### SUMMARY OF THE INVENTION

One aim of the invention is to improve the sealing of an opening that might form in a wall of a tank.

For this purpose provision is made, according to an aspect of the invention, for an assembly for a tank comprising:
an inner wall delimiting a cavity intended to receive a liquid, the inner wall having a first surface facing the cavity, and a second surface, opposite the first surface with respect to the cavity;
a sealing device comprising a sealing layer and a guide, the sealing layer comprising a material, the sealing device being attached at the level of the second surface of the inner wall, the material being expandable when an opening is formed in the inner wall, the guide being configured to be attached to the sealing layer so as to exert a stress on the sealing layer to control a direction of expansion of the sealing layer.

Advantageously, but optionally, the assembly previously described comprises one of the following features, taken alone or in combination:
the sealing layer comprises a panel having a thickness, a length and a width, the thickness being at least ten times less than the length and/or the width, preferably at least a hundred times less, the direction of expansion being along the length and/or along the width of the panel;
the sealing layer has two faces, the guide comprises two films attached to one of the two corresponding faces of the sealing layer;
each of the films is sewn onto one of the two corresponding faces of the sealing layer;
the sealing device is bonded onto the second surface of the inner wall;
it further comprises a liquid-tight coating attached to the first surface of the inner wall;
the coating has a first elastic modulus and the inner wall has a second elastic modulus, the first elastic modulus being greater than the second elastic modulus; and
it further comprises an outer wall arranged on the sealing device such that the sealing device is positioned between the inner wall and the outer wall.

According to another aspect of the invention, provision is made for a tank comprising an assembly as previously described.

According to another aspect of the invention, provision is made for an aircraft comprising a tank as previously described.

### DESCRIPTION OF THE FIGURES

Other features, aims and advantages of the invention will become apparent from the following description, which is purely illustrating and non-limiting, and which must be read with reference to the appended drawings on which:

FIG. 1 is a schematic section view of an assembly according to an embodiment of the invention.

FIG. 2 is a schematic section view of an assembly according to an embodiment of the invention, when the inner wall has been punctured.

FIG. 3 is a schematic section view of a wall of a tank which is not equipped with a sealing device according to an embodiment of the invention and which has been punctured.

In all the figures, similar elements bear identical reference numbers.

### DETAILED DESCRIPTION OF THE INVENTION

An aircraft (not shown) is an apparatus configured to rise and/or travel through air. Examples of aircraft comprise airplanes, but also helicopters.

For the needs of its operation, the aircraft may comprise a certain number of liquids (or fluids), which are generally circulated in dedicated circuits of the aircraft. Examples of fluids comprise lubrication oil or fuel, which is, usually, used for the operation of an internal combustion engine, the work of which is used for the benefit of the aircraft.

Each fluid useful to the operation of the aircraft can be stored in one or more tanks (not shown) of the aircraft.

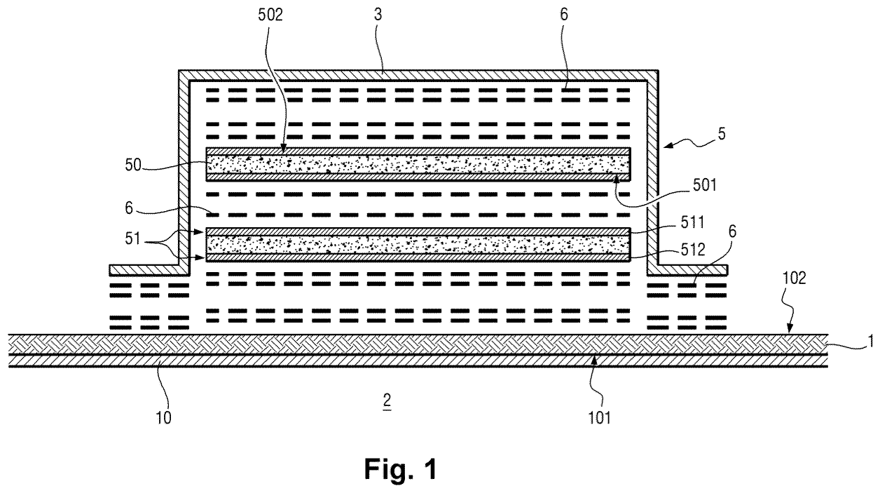

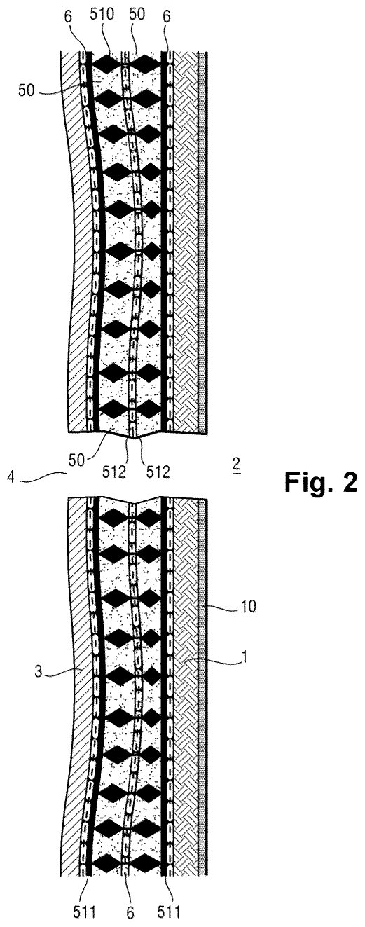

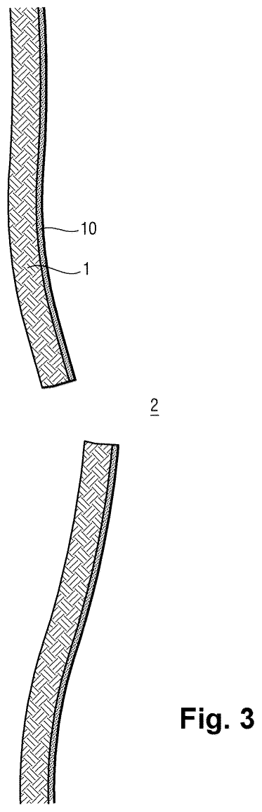

With reference to FIG. 1, to FIG. 2 and to FIG. 3, the reservoir then comprises an inner wall 1, liquid-tight, serving to ensure the mechanical withstand of the tank, and delimiting a cavity 2 intended to receive the liquid. In the following text, the words “inner” and “outer” are defined with respect to the cavity 2, an inner element being arranged nearer to the cavity 2 than an outer element. The inner wall 1 may comprise at least one from among the following materials: polyamides, polyesters, aramids (meta- and para-aramids) or a blend of these fibers.

The tank further comprises an outer wall 3 surrounding the inner wall 1, and which can also serve to ensure the mechanical withstand of the tank, typically in the event of an accident of the aircraft. The outer wall 3 can typically comprise a woven polymer, or even be formed of a layer of polymer weave. More generally, the outer wall 3 may comprise a plastic or a rubber which are reinforced, or not reinforced. Plastics useful for this purpose can be: polyurethanes, fluorinated plastics and/or polyamides. Rubbers useful for this purpose may be: nitriles, PVC/nitriles, hydrogenated nitriles, fluorinated elastomers and/or polyurethane elastomers.

As can be seen in particular in FIG. 1, the inner wall 1 has a first surface 101 facing the cavity 2, and a second surface 102, opposite the first surface 101 with respect to the cavity 2.

Preferably, a liquid-tight coating 10 is attached, typically being added on then bonded, to the first surface 101 of the inner wall 1, to guarantee that no fluid can escape from the cavity 2. More generally, the coating 10 constitutes a barrier to the content present in the tank, not only in its liquid form, but also for the vapors of the contents. In other words, the coating 10 prevents any passing of the tank contents from the inside of the cavity 2 to the outside of the cavity 2, whether these contents are in liquid or gas form. The coating 10 may typically comprise plastic, or be formed by a plastic film, or rubber. For certain flexible tanks, the coating 10 can be a coat, protected, or not protected, by another material which comes directly into contact with the contents of the tank. For certain stiff tanks, the coating 10 may comprise metal, such as aluminum, a composite material and/or a resin. In other advantageous examples, the coating 10 comprises at least one thermoplastic element having the barrier properties previously described, typically a polyamide, a fluorinated plastic and/or a PEEK (polyether ether ketone). In an advantageous variant (not shown), a fabric can be added on and attached at the level of an inner surface of the coating 10 to protect it from attacks coming from inside the cavity 2, typically when fitting accessories, such as a pump, inside the tank.

In a variant, the coating 10 has a first elastic modulus and the inner wall 1 has a second elastic modulus, the first elastic modulus being greater than the second elastic modulus. The inner wall 1 thus makes it possible to stiffen the coating 10.

In a variant (not shown), the inner wall comprises several portions, adjacent or not, each having a density and/or an elastic modulus which is different from that of the other portions. These portions may be areas of the inner wall which comprise different materials, or with zones comprising the same material but at different levels of porosity, or even in certain areas comprising a composite material and others not. These portions can take the form of layers distinct from the inner wall. Typically, the inner wall may comprise the same material (or materials) as the outer wall, but it is preferable that at least one from among the inner wall and the outer wall comprises a mechanical reinforcement fabric. In all circumstances, the presence of these different portions makes it possible to optimize the mechanical structure and/or impermeability of the inner wall, where applicable by reinforcing certain areas particularly exposed to projectiles, while limiting the costs of manufacturing and maintenance of the tank.

When the aircraft is in operation, as can be seen in FIG. 2 and FIG. 3, an opening 4, or puncture, can be formed within the inner wall 1, or even through the inner wall 1, i.e. from one side of the inner wall 1 to the other, and even, in certain cases, in the outer wall 3 and/or through the outer wall 3. This can in particular be the case when a projectile reaches the tank with sufficient energy. In this case, the liquid-tightness of the inner wall 1 is no longer guaranteed, and there is a risk of the fluid spreading outside the cavity 2, typically within the aircraft, which endangers the operational safety of the aircraft.

To limit the effects of any opening 4 that may be formed in the inner wall 1, a sealing device 5 is attached at level of the second surface 102 of the inner wall 1, as illustrated on FIG. 1 and on FIG. 2.

Preferably, the sealing device 5 is positioned between the inner wall 1 and the outer wall 3. The outer wall 3 in particular makes it possible to keep the sealing device 5 on the tank and guarantee its sealing and its insulation from the outside environment (e.g. abrasion on the surface of the aircraft, fluids, attacks on the installation, etc.). The sealing device 5 is not necessarily positioned between the inner wall 1 and the outer wall 3 over the entire surface occupied by the inner wall 1 and/or by the outer wall 3. Hence, as can be seen on FIG. 1, the sealing device 5 can be positioned at intermittent and distinct areas of the second surface 102 of the inner wall 1, the outer wall 3 being added directly onto the inner wall 1 outside these intermittent areas. In an advantageous variant (not shown), a natural gum can also be positioned between the inner wall and the outer wall, outside these intermittent areas, and in order to avoid the sealing device from being triggered for anything other than the formation of an opening in the inner wall.

In a variant illustrated on FIG. 1, the sealing device 5 is bonded, by means of a plurality of lines and/or dots of adhesive 6, to the second surface 102 of the inner wall 1. The same also applies for the attachment of the outer wall 3 to the sealing device 5 or to the inner wall 1. This is however not limiting since other means for attaching the sealing device 5 and/or the outer wall 3 to the inner wall 1 may be envisioned, such as welding, riveting, the use of clips and/or sewing.

As can be seen in FIG. 1, the sealing device 5 comprises at least one sealing layer 50, which comprises a material. In other words the sealing device 5 comprises a uniform expanse of the material, which is applied or deposited on a surface of the sealing device 5.

The sealing layer 50 has at least two faces 501, 502, typically an inner face 501 which faces the second surface 102 of the inner wall 1, and an outer face 502 which faces the outer wall 3. In other words, the faces 501, 502 extend on either side of the sealing layer 50 in the direction of the thickness of the sealing layer 50.

In a variant illustrated on FIG. 1, the sealing layer 50 comprises a panel, which has a thickness, a length and a width, the thickness being at least ten times less than the length and/or the width, preferably at least one hundred times less. The shape of the panel can be of any kind, or polygonal, or even circular, depending on the protection desired for the tank. Typically, the panel is a rectangular parallelepiped, which is of a thickness between 1.0 and 15.0 millimeters, and preferably has a value of 3.0 millimeters, the length is between 500 and 700 millimeters, and preferably has a value of 650 millimeters, and the width is between 400 and 600 millimeters, and preferably has a value of 550 millimeters. The sealing layer 50 can, of course, comprise a plurality of panels, typically superimposed in the direction normal to the inner wall 1, by being for example attached to one another.

The material is expandable, i.e. it is liable to expand or increase in volume or in surface. More precisely, the material is expandable when the opening 4 is formed in the inner wall 1. In other words, it is the formation of the opening 4 in the inner wall 1, whether it is a through opening or not, which triggers the expansion of the material. Several types of materials may be envisioned in this regard.

In a variant, the sealing occurs extrinsically to the material. In this case, the material comprises sealing components such as microcapsules or nanocapsules, which are incorporated into a matrix, preferably polymer, forming the sealing layer 50, and contain a mobile phase which is able to spread to obstruct the opening 4, when the components are broken. Chemical and/or physical reactions may lead to an expansion of the material when the components of the capsules are broken. Hence, the capsules may contain a pressurized gas, which can be generated by chemical reaction. In other variants, a polyurethane foam, such as those found in the construction industry, can be used.

In another variant, the sealing is done intrinsically to the material. In this case, the material is configured such that the sealing is implemented by reconstruction of the chemical bonds within the material. The bonds concerned may be covalent or non-covalent bonds, such as hydrogen bonds, metal-ligand complexes, ionic interactions or pi stacking. To trigger the sealing, it is generally necessary for the material to be exposed to heat, typically at temperatures above 100 C, to an electrical and/or electromagnetic stimulus, and/or to irradiation.

In a variant, the expansion of the material is triggered independently: it is the formation of the opening 4 itself that triggers the expansion of the material.

In another variant, the expansion of the material is triggered non-independently: it is heat, light and/or contact with oxygen from the air or from a liquid, typically that contained in the cavity 2 and which tends to spread through the opening 4 when it forms, that triggers the expansion of the material. Typically, a polymer material, or a natural gum, is able to swell up when it absorbs fuel.

In an exemplary embodiment, the material comprises microcapsules distributed within different polymer matrices and containing repair agents, the sealing layer 50 comprising catalysts. In this exemplary embodiment, the use of the material is modular. Furthermore, the sealing is implemented independently simply by contact between the different substances forming the sealing layer 50 during the formation of the opening 4 within the inner wall 1. Typically, the sealing layer 50 comprises two liquids trapped and separated by an inert layer, these liquids being released during the formation of the opening 4 in the inner wall 1, the chemical reaction between the liquids forming a material sealing the opening 4, the diameter of which can exceed 20 millimeters.

In another exemplary embodiment, the sealing layer 50 comprises a thermoplastic elastomer, two types of reagent being encapsulated and dispersed in this elastomer layer. During the formation of the opening 4 in the inner wall 1, the two reagents come into contact and the chemical reaction produces a rapid-expansion polyurethane foam which obstructs the opening 4. Here again, it is preferable to make provision for a reaction between two reagents and a blowing agent, i.e. an element used to form a gas. The gas can be produced from a liquid heated by a chemical reaction, or form following a chemical reaction.

In other exemplary embodiments, the material of the sealing layer 50 comprises synthetic isoprene, butyl rubber, polyisobutylene and/or EPDM (ethylene propylene diene monomer), which are elastomers that swell by absorption of fuel.

Note that, in such exemplary embodiments, the sealing device 5 can be single-use. Furthermore, the use of capsules can limit the mechanical withstand and lifetime of the sealing device 5.

In an exemplary embodiment illustrated on FIG. 1 and on FIG. 2, the material of the sealing layer 50 reacts in contact with the liquid contained in the cavity 2, which is able to spread outside of the cavity 2 if the opening 4 forms in the inner wall 1. Advantageously, the material is designed to be expandable at any temperature, which is favorable to the operating range of the aircraft, particularly at temperatures between −55° C. and 85° C. One example of a material able to be used for this comprises rubber. Another example of a material comprises a polyurethane foam. Another example of a material comprises a natural gum in the form of a solid foam, vulcanized or otherwise.

To promote a quick and thorough sealing of the opening 4 when it is formed inside the inner wall 1, the sealing device 5 comprises at least one guide 51, which is configured to be attached to the sealing layer 50 so as to exert a stress on the sealing layer 50 to control a direction of expansion of the sealing layer 50.

A comparison of FIG. 2, illustrating a part of a tank equipped with a sealing device 5 comprising an expandable material and a guide 51, and of FIG. 3, illustrating a part of a tank which is not equipped with such a sealing device 5, makes it possible to understand the benefit of stressing the sealing layer 50 to control a direction of expansion thereof. Hence, as can be seen in FIG. 2, the extent of the injury generated by the formation of the opening 4 in the inner wall 1 is limited owing to the stress exerted by the guide 51 in the thickness of the sealing layer 50. By orienting the expansion of the material in the direction corresponding to the length and/or width of the sealing layer 50, i.e. substantially in the plane of the sealing layer 50, the opening 4 is sealed more effectively and more quickly, the loss of liquid from out of the cavity 2 then being reduced, or even eliminated. Furthermore, the presence of the guide 51 has a favorable stiffening effect on the inner wall 1 and/or on the outer wall 3, which limits configurations such as those illustrated in FIG. 3, in which the formation of the opening 4 caused by a projectile impact causes the offsetting of the plane of the edges of the opening 4, with respect to one other. Thus, the inner wall 1 and/or the outer wall 3 of the tank illustrated in FIG. 2 is stiffer than the inner wall 1 and/or the outer wall 3 of the tank illustrated in FIG. 3.

Typically, with reference to FIG. 2, the direction of expansion is along the length and/or along the width of the panel, in the variant in which the sealing layer 50 comprises a panel. In other words, the guide 51 exerts such a stress in the direction of the thickness of the panel that the material can only extend along the width and/or the length of the panel when the opening 4 forms in the inner wall 1.

In an advantageous variant illustrated in FIG. 1, the guide 51 comprises two films 511, 512. A film is defined here as a film, a thin film of a product or of a material covering a surface. Each of the films 511, 512 is added on and attached to one of the two faces 501, 502 of the sealing layer 50. This is however not limiting since the films 511, 512 may be formed by outer portions of the sealing layer 50 which are stiffer than the rest of the sealing layer 50, for example the films 511, 512 may be the sealed skins of a foam forming the sealing layer 50.

FIG. 1 illustrates an embodiment wherein the sealing device 5 comprises two sealing layers 50, each being guided by two films 511, 512 attached on each of their two faces 501, 502. A greater number of sealing layers 50 can, of course, be envisioned. However, this shape of the guide 51, in which two films 511, 512 sandwich the sealing layer 50, is not limiting, since it is possible for the guide 51 to comprise only a single film, which would be either attached to only one of the two faces 501, 502, or completely surround the sealing layer 50 leaving it free to extend along a single direction in space. In an advantageous variant, the two films 511, 512 can be connected to one another, for example by means of a seam, a staple and/or a return element, such as a spring, used to maintain a given distance between the films 511, 512.

Advantageously, each film 511, 512 has a thickness between 20 and 50 microns, and preferably having a value of 30 microns.

Preferably, the film 511, 512 comprises polyamide. This is however not limiting, since other materials may be envisioned, such as a polymer or a metal, as long as the material of the guide 51 is inert to the liquid contained in the cavity 1, i.e. unlike the material of the sealing layer 50, it does not react in contact with this liquid.

The film 511, 512 may be composed of a homogenous or woven material, according to the stresses it is desirable to exert on the sealing layer 50. The film 511, 512 can be flexible and then comprise leaves, coated fabric, calendared fabric and/or a gum. The film 511, 512 can be stiff, or semi-stiff, and comprise a composite panel, a plastic and/or compressed fibers.

In a preferred variant, moreover illustrated on FIG. 2, the film 511, 512 is sewn onto the sealing layer 50, each of the two films 511, 512 being preferably sewn onto one of the two corresponding faces 501, 502 of the sealing layer 50. More accurately, the two films 511, 512 are advantageously connected to one another by sewing yarns traversing the sealing layer 50, which makes it possible to set the thickness of the sealing layer 50. Preferably, the seam lines are straight, in a lockstitch pattern, and have been made with a spacing between 5 and 15 millimeters, and preferably having a value of 10 millimeters, in the direction of the width and the length of the panel forming the sealing layer 50. Furthermore, the density of the stitches is at least 10 stitches every 10 centimeters, preferably at least 15 stitches every 10 centimeters. It is possible for the seam to not be straight, and thus to follow any pattern, such as crosses or broken lines forming alternating salient and reentrant angles (zigzag). The pattern and properties of the seam generally depend on the characteristic size of the projectile liable to cause the formation of the opening 4 in the inner wall 1.

The seam has the advantage of ensuring the integrity of the sealing layer 50 outside the area concerned by the forming of the opening 4 within the inner wall 1. Furthermore, the sewing yarns 510 may be chosen so as to have a certain capillary effect, promoting the diffusion of liquid within the sealing layer 50 and increasing the quantity of material exposed to the liquid (according to the same principle of operation as drains), thus attenuating certain physical-chemical properties of the material of the sealing layer 50, which may have a gradient of porosity, from the outside toward the core of the sealing layer 50 (the core being more porous than the peripheral areas of the sealing layer), which might limit the propagation of liquid within the sealing layer 50, and therefore the expansion of the material. Finally, the sewing yarns 510 may be of memory type, so as to tighten when they come into contact with the fluid or when they are subjected to a thermal stress, exerting an even greater stress on the sealing layer 50. Preferably, the yarns 510 comprise a polyamide, a polyester and/or an aramid.

In a variant, the guide 51 comprises only seams in the sealing layer 50 (with properties, patterns and shapes as previously described), which suffice to stress the sealing layer 50 enough to control a direction of expansion of the sealing layer 50, without the presence of any film(s) being necessary.

Alternatively or in addition to the seams, it is possible to envision a guide comprising staples, rivets, screws (plastic, composite and/or metallic) and/or inserts, either directly attached to the sealing layer, or to attach at least one film onto the sealing layer.

Note that, although the sealing device 5 has been described for an attachment to the inner wall 1 of a tank, this is not limiting, since such a sealing device 5 can also be added on and attached to a wall of any fluid duct.

Owing to the sealing device 5, it is not only possible to limit the effects of an opening 4 that might be formed transversally through the inner wall 1, but also, to a certain extent, an opening 4 that might be formed at an angle to the normal to the plane of the inner wall 1, typically a tear in the plane of the inner wall 1.

1-9. (canceled)

10. An assembly comprising:
an inner wall delimiting a cavity, the inner wall having a first surface facing the cavity, and a second surface opposite the first surface with respect to the cavity; and
a sealing device attached to the second surface and comprising a sealing layer comprising a material expandable when an opening is formed in the inner wall, and a guide attached to the sealing layer so as to exert a stress on the sealing layer to control a direction of expansion of the material of the sealing layer;
wherein the sealing layer has a first face and a second face, and the guide comprises a first film attached to the first face and a second film attached to the second face.

11. The assembly of claim 10, wherein the sealing layer comprises a panel made of the material and having a thickness, a length and a width, wherein the thickness is at least ten times less than the length and/or the width.

12. The assembly of claim 10, wherein the first film is sewn onto the first face and/or the second film is sewn onto the second face.

13. The assembly of claim 10, wherein the sealing device is bonded to the second surface.

14. The assembly of claim 10, further comprising a liquid-tight coating attached to the first surface.

15. The assembly according of claim 14, wherein the liquid-tight coating has a first elastic modulus and the inner wall has a second elastic modulus, the first elastic modulus being greater than the second elastic modulus.

16. The assembly of claim 10, further comprising an outer wall, the sealing device being positioned between the inner wall and the outer wall.

17. A tank comprising the assembly of claim 10.

18. An aircraft comprising the tank of claim 17.
